(19) United States
(12) Patent Application Publication
(10) Pub. No.: US 2003/0119500 A1
(43) Pub. Date: Jun. 26, 2003

(54) SYSTEM AND METHOD FOR PROVIDING TERMINAL MOBILITY IN H.323 SYSTEMS

(76) Inventors: SUBRATA MUKHERJEE, PLANO, TX (US); MAHESH PATEL, PLANO, TX (US)

Correspondence Address: JENKENS & GILCHRIST, PC, 1445 ROSS AVENUE, SUITE 3200, DALLAS, TX, 75202, US

(21) Appl. No.: 09/223,202

(22) Filed: Dec. 30, 1998

(51) Int. Cl. H04Q 7/20

(52) U.S. Cl. 455/433; 455/435

(57) ABSTRACT

A telecommunications system and method is disclosed for providing for terminal mobility between H.323 networks belonging to the same H.323 system. When an H.323 mobile terminal moves to a new or visitor H.323 network and attempts to register with the visitor H.323 network, the visitor H.323 network informs the home H.323 network to which the H.323 mobile terminal belongs about the move, using an H.225 Registration and Admission Control Signaling (RAS) message. In order to send such a location update RAS message to the home H.323 network, the visitor Gatekeeper determines the home Gatekeeper of the visiting H.323 mobile terminal. Thereafter, the RAS message is sent by the Gatekeeper of the visitor H.323 network to the Gatekeeper of the home H.323 network through routers and the LAN backbones of the H.323 networks of the H.323 system.

### BACKGROUND OF THE PRESENT INVENTION

1. Field of the Invention

The present invention relates generally to telecommunications systems and methods for providing an H.323 architecture within a local area network, and specifically to providing terminal mobility between H.323 networks belonging to the same H.323 system.

### BACKGROUND AND OBIECTS OF THE PRESENT INVENTION

Until recently, it has been relatively easy to define Wide Area Networks (WANs) and Local Area Networks (LANs) and to point out their differences. However, it is becoming increasingly difficult to distinguish WANs and LANs because the terms wide area and local area do not have the meaning they once had. For example, a LAN in the 1980s was generally confined to a building or a campus where the components were no more than a few hundred or few thousand feet from each other. Today, LANs may span scores of miles.

Nonetheless, certain characteristics are unique to each of these networks. A WAN is usually furnished by a third party. For example, many WANs are termed public networks because the telephone company or a public data network (PDN) vendor owns and manages the resources and rents these services to users. By contrast, a LAN is usually privately owned. The cables and components are purchased and managed by an enterprise.

The first LANs were proprietary and developed to support unintelligent user workstations in which a primary station controlled the operations of the attached devices (secondary stations). The effectiveness of this technology decreased because the master/slave protocol was too slow and cumbersome. Therefore, new types of LANs were developed, such as Ethernet LANs and token-ring LANs. Ethernet LANs and token-ring LANs are designed for data applications and use a shared medium (bus or ring, respectively) designed for 10 Mbit/s speeds or higher up to Gigbit speeds. However, during periods of high activity, the shared medium does not respond well to all users, which results in degraded response time and throughput. Therefore, Switched Ethernet LANs were developed to provide more capacity to the end users. Switched Ethernet LANs do not rely on sharing the media. Instead, Switched Ethernet LANs provide point-to-point bandwidth between the user station and a switch. Another type of LAN being developed alongside the Switched Ethernet LAN is the Asynchronous Transfer Mode (ATM) based LAN, which utilizes very high-speed ATM switches that support multimedia applications.

On top of these different networking architectures, such as Switched Ethernet or ATM, which define the physical attributes of the communications network, many LANs have begun using Internet Protocol (IP) to route data between hosts on the network. The data is routed in datagrams, hereinafter referred to as packets, and is transmitted using connection-less network services. Therefore, IP does not guarantee the reliable delivery of the data or the sequencing of the packet. Hence, an upper layer, such as Transmission Control Protocol (TCP) or User Datagram Protocol (UDP), must provide this function. TCP connection-oriented services provide reliable delivery of data between the host computers by establishing a connection before the applications send data. Thus, TCP guarantees that the data is error free and in sequence. On the other hand, UDP connection-oriented services are used by various applications to send messages where the integrity of the data is not as important.

Data can be sent across a LAN from an originating host computer to a receiving host computer using the IP routing protocol by encapsulating the data sent by the originating host computer into an IP packet, which includes an IP header. The IP header identifies the address of the receiving host computer. The IP packet and header can then be further encapsulated into the specific protocol of the transit network, such as an Ethernet LAN, for delivery of the IP packet and header to an IP router.

After the transit network has delivered the IP packet and header to the IP router, the IP router strips away the control information and uses the destination address in the packet header to determine where to route the traffic. Typically, the IP router then passes the packet back to the sub-network by invoking a sub-network access protocol, such as Ethernet on the LAN. This protocol is used to encapsulate the packet header and user data into the headers and trailers that are used by the sub-network to deliver the data to the receiving host computer. It should be understood that routers can also be used to transport data to other LANs or WANs. LANs not only interconnect computers for data communications, but can also interconnect terminals for voice communications. For example, many LANs are now implementing H.323 architecture to provide multimedia communications services over LANs. H.323 entities may be integrated into personal computers or implemented in stand-alone devices, such as wireline or wireless terminals, e.g., video or audio telephones. H.323 entities can provide real-time audio, video and/or data communications capabilities in point-to-point or multipoint conferences.

An H.323 system is shown in FIG. 1 of the drawings. When a first user logs-on to a first H.323 terminal 120, which can be, for example, a personal computer or IP telephone, e.g., by providing a user name and password, a Registration and Admission Control Signaling (RAS) message 115 is sent from the first H.323 terminal 120 to a Gatekeeper 180, which stores an IP routing address 187 within a subscriber record 185 associated with the first user for the first H.323 terminal 120. Thereafter, when a second user on a second H.323 terminal 125 places a call to the first user on the first H.323 terminal 120, e.g., by dialing a telephone number or user ID for the first user, the call is routed over the LAN backbone 110 to the Gatekeeper 180, which retrieves the address 187 for the first H.323 terminal 120 and re-directs the call to the first H.323 terminal 120. When the call connection is established between the first and second H.323 terminals 120 and 125, respectively, IP voice packets are sent between the first and second H.323 terminals 120 and 125, respectively, without necessarily being routed through the Gatekeeper 180. It should be noted that calls can be placed to and from the Public Land Mobile Network (PLMN)/Public Switched Telephone Network (PSTN) 160 through a Public Gateway (PG) 150. IP voice packets are sent between one of terminals 120 or 125 and the PG 150 before being converted into the PLMN/PSTN 160 format.

If, however, as shown in FIG. 2 of the drawings, the H.323 terminal 120 is a mobile terminal, such as a cellular telephone, the H.323 mobile terminal 120 can log-on to the H.323 network 100 through a cellular network 190 within the H.323 network 100 by providing, for example, an International Mobile Subscriber Identity (IMSI) number 122 uniquely identifying the mobile subscriber. The mobile communications system 190, which can itself be considered an H.323 terminal, includes an Access Node (AN) 130, which combines a part of a Mobile Switching Center (MSC) functionality 134 for handling mobility management and controlling calls made to and from H.323 mobile terminals 120 within the H.323 network 100 and a Base Station Controller (BSC) functionality 132 for controlling radio-related functions, such as channel assignment, and at least one A-bis Gateway 142 and associated BTS 140, all of which are connected to the LAN backbone 110. It should be noted that the BTS 140 is connected to the LAN backbone 110 via the A-bis Gateway 142. The A-bis Gateway 142 converts between circuit-switched signaling used by the BTS 140 and packet-switched signaling used by the H.323 network 100. The BTS 140 operates as a transceiver for transmitting and receiving data and control messages to and from the MS 120 over an air interface 146.

Wireless voice communications are transported through the LAN backbone 110 between A-bis Gateways 142, between an A-bis Gateway 142 and the PG 150 or between an A-bis Gateway 142 and another H.323 terminal (120 or 125 in FIG. 1) via UDP/IP. As mentioned hereinbefore, the PG 150 provides the interconnection between the packet based H.323 network 100 and the circuit switched public telephone network, e.g., PLMN/PSTN 160. Speech and data are transmitted within the H.323 network 100 and through the Internet 175 using an IP Router 170.

The cellular system 190 within the H.323 network 100 may also include a Home Location Register (HLR) 155 for storing location information, e.g., the address of the Gatekeeper 180, and non-H.323 network 100 related subscriber information associated with the H.323 mobile terminals 120 belonging to the H.323 network 100. However, all of the permanent H.323 subscriber information relating to services offered to the subscribers belonging to the H.323 network 100 are stored within the Gatekeeper 180, which also is responsible for determining whether an H.323 subscriber is currently within the H.323 network 100. For example, the H.323 network 100 may offer a call forwarding service to subscribers, some of which may subscribe to the service. Thus, the H.323 network 100 operator can provide uniquely tailored service to each of the subscribers registered within the H.323 network 100.

However, with reference now to FIG. 3 of the drawings, when an H.323 mobile terminal 120 having it's subscriber services stored within the Gatekeeper 180a of a first H.323 network 100a moves to a second H.323 network 100b belonging to the same H.323 system 105 and interconnected by Routers 170a and 170b, there is currently no mechanism for allowing the Gatekeeper 180b within the second H.323 network 100b to communicate with the first H.323 network 100a to inform the first H.323 network 100a that the H.323 mobile terminal 120 has moved. Consequently, the H.323 mobile terminal 120 cannot access the second H.323 network 100b.

It is, therefore, an object of the present invention to allow for terminal mobility between H.323 networks belonging to the same H.323 system.

### SUMMARY OF THE INVENTION

The present invention is directed to telecommunications systems and methods for providing for terminal mobility between H.323 networks belonging to the same H.323 system. When an H.323 mobile terminal moves to a new or visitor H.323 network and attempts to register with the visitor H.323 network, the visitor H.323 network can inform the home H.323 network to which the H.323 mobile terminal belongs about the move, using an H.225 RAS message. In order to send such a location update RAS message to the home H.323 network, the visitor Gatekeeper must first determine the home Gatekeeper of the visiting H.323 mobile terminal. Thereafter, the RAS message can be sent by the Gatekeeper of the visitor H.323 network to the Gatekeeper of the home H.323 network through routers and the LAN backbones of the H.323 networks of the H.323 system.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram of components in an H.323 local area network based upon internet protocol;

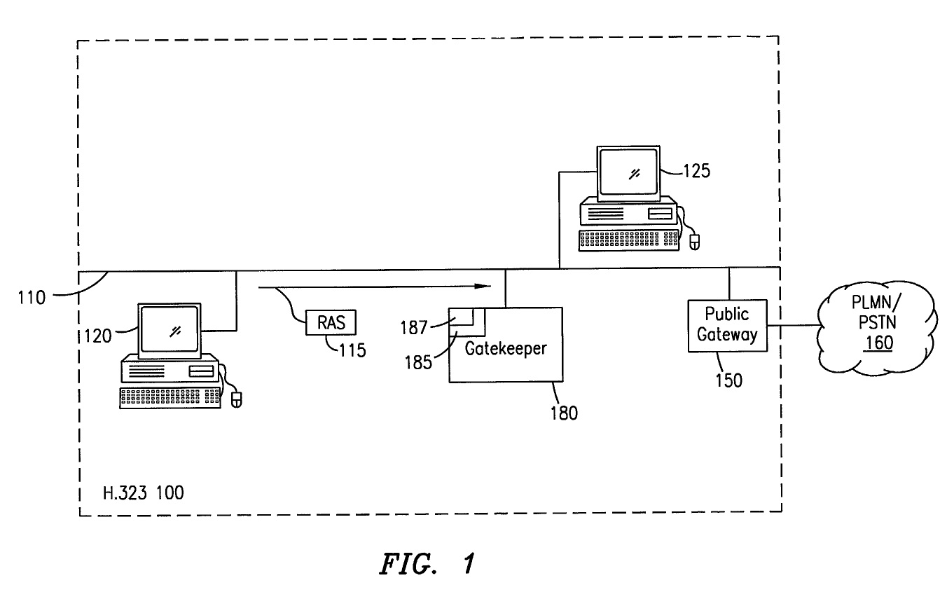

FIG. 2 is a block diagram of components in an H.323 local area network based upon internet protocol that provides mobile communications;

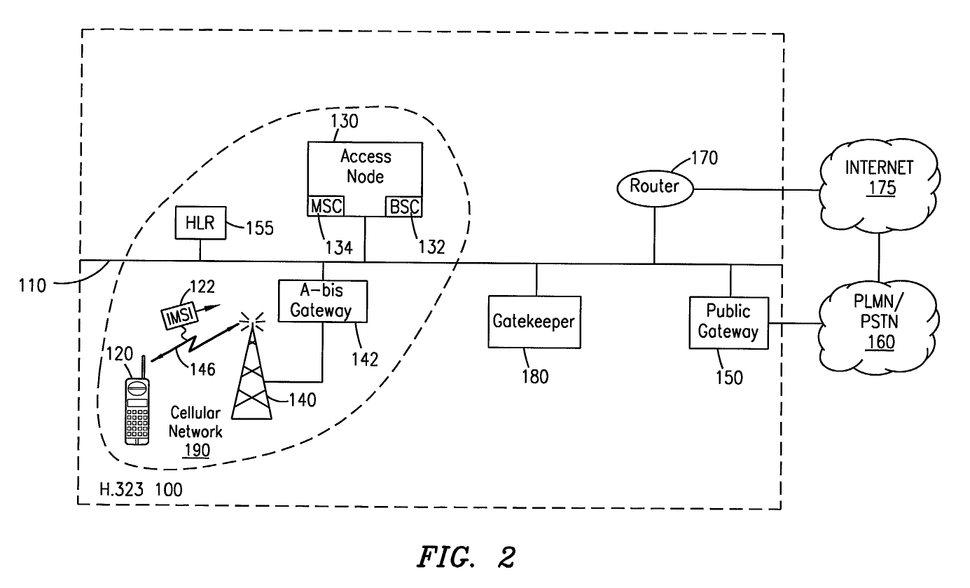

FIG. 3 illustrates the problem of terminal mobility between two H.323 networks belonging to the same H.323 system;

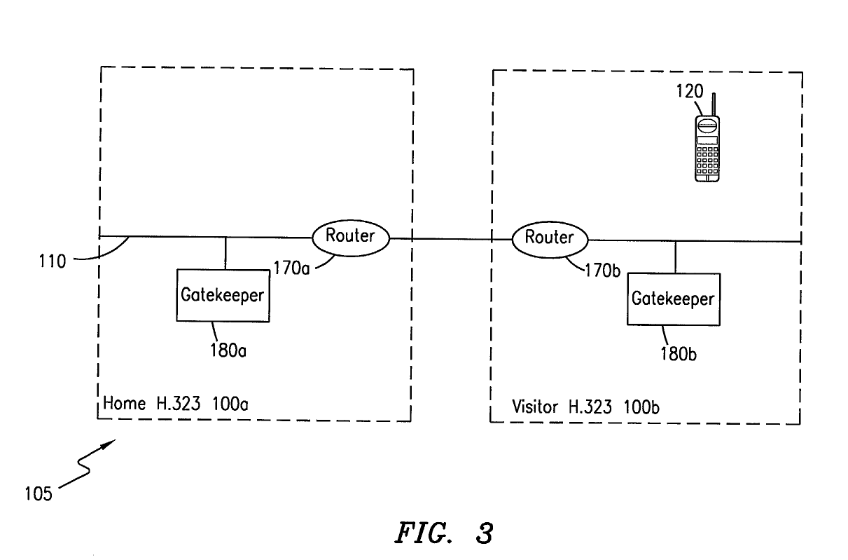

FIG. 4 illustrates a location update process of an H.323 mobile terminal between two H.323 networks belonging to the same H.323 system in accordance with preferred embodiments of the present invention;

FIG. 5 is a flow chart illustrating the steps for implementing the location update process illustrated in FIG. 4 of the drawings; and

FIG. 6 illustrates the routing of an incoming call to an H.323 mobile terminal that has moved to a visitor H.323 network in accordance with embodiments of the present invention.

### DETAILED DESCRIPTION OF THE PRESENTLY PREFERRED EXEMPLARY EMBODIMENTS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

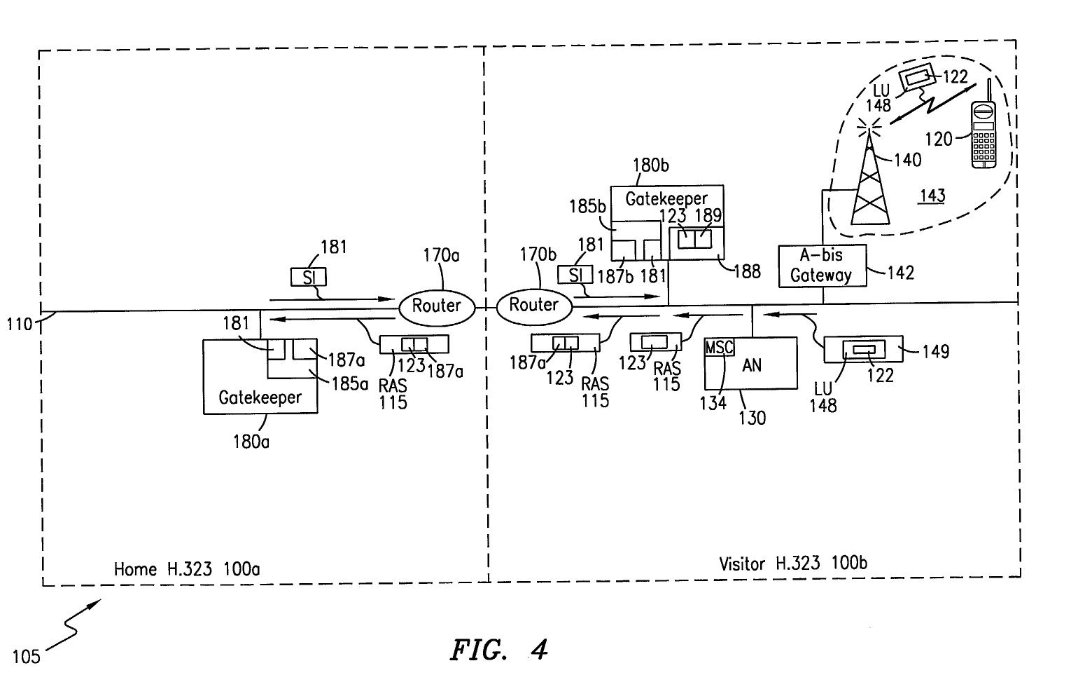

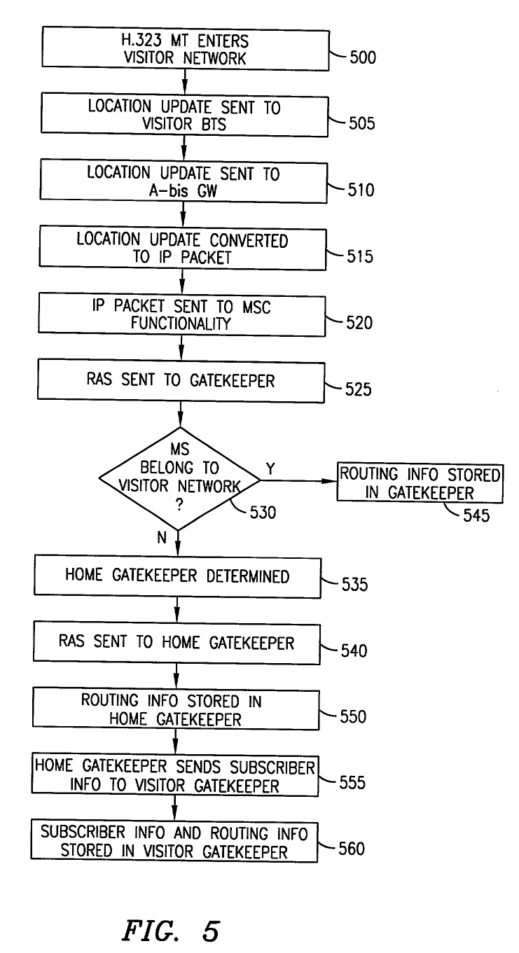

With reference now to FIG. 4 of the drawings, which will be described in connection with the steps listed in FIG. 5 of the drawings, when an H.323 mobile terminal 120, which belongs to a home H.323 network 100a, enters an area covered by a visitor H.323 network 100b within an H.323 system 105 (step 500), the H.323 mobile terminal 120 will attempt to register with the visitor H.323 network 100b by sending a location update message 148 to a Base Transceiver Station (BTS) 140 serving an area 143 that the H.323 mobile terminal 120 is located in (step 505). The location update message 148 includes identity information, such as an International Mobile Subscriber Identity (IMSI) number 122, which uniquely identifies the H.323 mobile terminal 120.

The BTS 140 will forward the location update message 148 to an A-bis Gateway 142 (step 510), which converts the location update message 148 into an Internet Protocol (IP) packet 149 containing the location update message 148, which includes the IMSI 122 (step 515), for transmission of the IP packet 149 over a Local Area Network (LAN) backbone 110 to Mobile Switching Center (MSC) functionality 134 within an Access Node (AN) 130 connected to the LAN backbone 110 (step 520). The MSC functionality 134 receives the IP packet 149 containing the location update message 148, which includes the IMSI 122, and transmits an H.225 Registration and Admission Control Signaling (RAS) message 115, which includes a subscriber number 123 or other alias of the IMSI number 122, such as an e-mail address, based upon the received location update message 148 to a Gatekeeper 180b of the visitor H.323 network 100b (step 525), using User Datagram Protocols over Internet Protocols (UDP/IP).

When the visitor Gatekeeper 180b determines that the H.323 mobile terminal 120 does not belong to the visitor network 100b (step 530), the visitor Gatekeeper 180b must determine the home H.323 network 100a of the H.323 mobile terminal 120. In order to inform the home H.323 network 100a of the current location of the H.323 mobile terminal 120, the visitor Gatekeeper 180b must determine the identity of the Gatekeeper 180a associated with the H.323 mobile terminal's home H.323 network 100a (step 535). As an example, a table 188 can be included within the visitor Gatekeeper 180b for cross-referencing alias or subscriber numbers 123 with address information 189 for serving Gatekeepers 180a. The visitor Gatekeeper 180b can access this table 188, and, using the alias or subscriber number 123 provided in the RAS message 115, determine address information 189 for the home Gatekeeper 180a.

The visitor Gatekeeper 180b can send the RAS message 115, along with an address 187a for the visitor Gatekeeper 180b and the alias or subscriber number 123, to the home Gatekeeper 180a using the determined address information 189 for the home Gatekeeper 180a (step 540). The RAS message 115 can be sent by the visitor Gatekeeper 180b of the visitor H.323 network 100b to the home Gatekeeper 180a of the home H.323 network 100a through routers 170b and 170a, respectively, and the LAN backbone 110 of the H.323 system 105 (step 540). It should be noted that if the H.323 mobile terminal 120 did belong to the visitor H.323 network 100b (step 530), the Gatekeeper 180b would store within a subscriber record 185b for the H.323 mobile terminal therein routing information 187b for the H.323 mobile terminal 120 (step 545), which would normally be the IP address for the MSC functionality 134 serving the H.323 mobile terminal 120.

When the home Gatekeeper 180a receives the RAS message 115 (step 540), the home Gatekeeper 180a stores routing information 187a for the H.323 mobile terminal 120 within a subscriber record 185a for the H.323 mobile terminal 120 therein (step 550). The routing information 187a can be, for example, the IP address 187a for the visitor Gatekeeper 180b. In addition, in response to the RAS message 115, the home Gatekeeper 180a forwards subscriber information 181 associated with the H.323 mobile terminal 120 to the visitor Gatekeeper 180b (step 555) for storage in the subscriber record 185b within the visitor Gatekeeper 180b (step 560). This subscriber information 181 can be used by the visitor Gatekeeper 180b to provide the services to the H.323 mobile terminal 120 that the H.323 mobile terminal 120 subscribed to in the home H.323 network 100a.

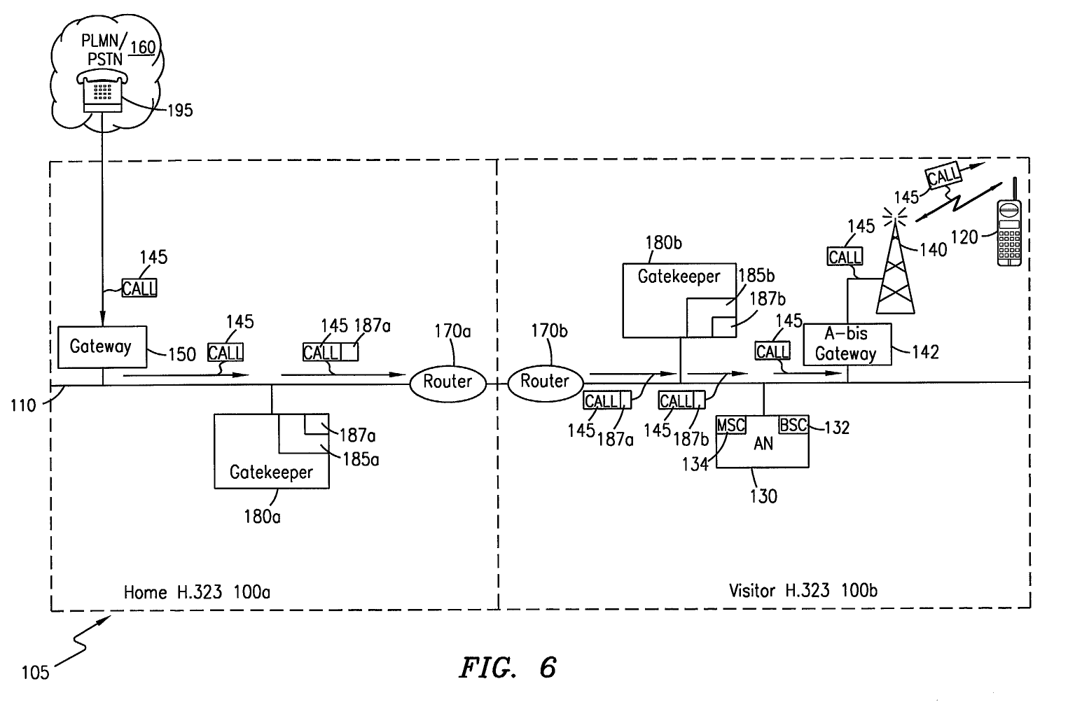

With reference now to FIG. 6 of the drawings, when a subscriber 195 outside the H.323 system, e.g., a subscriber within either the Public Land Mobile Network (PLMN) or Public Switched Telephone Network (PSTN) 160, places a call 145 to the H.323 mobile terminal 120, the call 145 is routed to the Gatekeeper 180a of the home H.323 network 100a via a Public Gateway 150 of the home H.323 network 100a. The home Gatekeeper 180a accesses the H.323 mobile terminal's subscriber record 185a to determine routing information 187a for the incoming call 145. Using H.225 call control signaling (Q.931 ) and the IP address 187a for the visitor Gatekeeper 180b, the home Gatekeeper 180a routes the call 145 to the visitor Gatekeeper 180b through routers 170a and 170b, respectively, and the LAN backbone 110 of the H.323 system 105.

When the visitor Gatekeeper 180b receives the incoming call 145 to the H.323 mobile terminal 120, the visitor Gatekeeper 180b determines the IP address 187b for the MSC functionality 134 serving the H.323 mobile terminal 120 by accessing the subscriber record 185b associated with the H.323 mobile terminal 120 within the visitor Gatekeeper 180b. The visitor Gatekeeper 180b routes the incoming call 145, using H.225 call control signaling (Q.931 signaling) and the IP address 187b for the MSC functionality 134, to the serving MSC functionality 134. The MSC functionality 134 sets up the call 145 to the H.323 mobile terminal 120 by requesting BSC functionality 132 within the Access Node 130 to page the H.323 mobile terminal 120 via the BTS 140. When the H.323 mobile terminal 120 responds to the page, the BSC functionality 132 allocates a traffic channel for the call 145 and the call connection between the calling subscriber 195 and the H.323 mobile terminal 120 can be established. It should be understood that the aforementioned routing procedure for incoming calls 145 to the H.323 mobile terminal 120 would be the same regardless of where the incoming call was originated, e.g., outside the H.323 system 105 or inside the H.323 system 105.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A telecommunications system for allowing mobility of an H.323 mobile terminal between H.323 networks belonging to the same H.323 system, comprising:
a home Gatekeeper within a home H.323 network associated with said H.323 mobile terminal; and
a visitor Gatekeeper within a visitor H.323 network for receiving a Registration and Admission Control Signaling (RAS) message from said H.323 mobile terminal within said visitor H.323 network, determining said home Gatekeeper using identity information within said RAS message and forwarding said RAS message to said determined home Gatekeeper.

2. The telecommunications system of claim 1, further comprising:
a table within said visitor Gatekeeper for cross-referencing said identity information with an address for said home Gatekeeper, said RAS message being sent from said visitor Gatekeeper to said home Gatekeeper using said address.

3. The telecommunications system of claim 1, wherein said identity information is a subscriber number associated with an International Mobile Subscriber Identity number.

4. The telecommunications system of claim 1, further comprising:
a first subscriber record associated with said H.323 mobile terminal within said home Gatekeeper for storing subscriber information and an address associated with said visitor Gatekeeper when said home Gatekeeper receives said RAS message.

5. The telecommunications system of claim 4, further comprising:
a second subscriber record associated with said H.323 mobile terminal within said visitor Gatekeeper for receiving said subscriber information from said home Gatekeeper and storing said subscriber information therein.

6. The telecommunications system of claim 1, further comprising:
a base transceiver station within said visitor H.323 network in wireless communication with said H.323 mobile terminal for receiving a location update message from said H.323 mobile terminal; and
a gateway connected to said base transceiver station for converting said location update message into an Internet Protocol packet.

7. The telecommunications system of claim 6, further comprising:
a local area network backbone; and
a mobile switching center functionality in communication with said gateway via said local area network backbone for receiving said Internet Protocol packet and transmitting said RAS message based upon said Internet Protocol packet to said visitor Gatekeeper.

8. The telecommunications system of claim 7, wherein said RAS message is transmitted from said mobile switching center function to said visitor Gatekeeper over said local area network backbone using Transmission Control Protocol over Internet Protocol.

9. A method for allowing mobility of an H.323 mobile terminal between H.323 networks belonging to the same H.323 system, comprising the steps of:
receiving, by a visitor Gatekeeper within a visitor H.323 network, a Registration and Admission Control Signaling (RAS) message from said H.323 mobile terminal, said H.323 mobile terminal being associated with a home H.323 network and being located within an area covered by said visitor H.323 network;
determining, by said visitor Gatekeeper, a home Gatekeeper within said home H.323 network using identity information within said RAS message; and
forwarding said RAS message from said visitor Gatekeeper to said determined home Gatekeeper.

10. The method of claim 9, wherein said step of determining further comprises the step of:
accessing a table within said visitor Gatekeeper to cross-reference said identity information with an address for said home Gatekeeper.

11. The method of claim 10, wherein said step of forwarding further comprises the step of:
sending said RAS message from said visitor Gatekeeper to said home Gatekeeper using said address.

12. The method of claim 9, further comprising the step of:
in response to said step of forwarding, storing, within a first subscriber record associated with said H.323 mobile terminal within said home Gatekeeper, subscriber information and an address associated with said visitor Gatekeeper.

13. The method of claim 12, further comprising the steps of:
in response to said step of forwarding, receiving, by said visitor Gatekeeper, said subscriber information associated with said H.323 mobile terminal from said home Gatekeeper; and
storing, within a second subscriber record associated with said H.323 mobile terminal within said visitor Gatekeeper, said subscriber information received from said home Gatekeeper.

14. The method of claim 13, further comprising the steps of:
receiving, by said home Gatekeeper, an incoming call to said H.323 mobile terminal;
accessing said first subscriber record to determine said address for said visitor Gatekeeper; and
routing said incoming call from said home Gatekeeper to said visitor Gatekeeper.

15. The method of claim 14, further comprising the steps of:
accessing, by said visitor Gatekeeper, said second subscriber record associated with said H.323 mobile terminal to retrieve said subscriber information and an address for serving mobile switching center functionality in wireless communication with said H.323 mobile terminal;
routing said incoming call to said serving mobile switching center functionality via a local area network backbone interconnecting said visitor Gatekeeper and said serving mobile switching center functionality, using said address; and
establishing, by said serving mobile switching center functionality, a call connection with said H.323 mobile terminal consistent with said subscriber information.

16. The method of claim 9, wherein said step of receiving further comprises the steps of:
receiving, by a base transceiver station within said visitor H.323 network in wireless communication with said H.323 mobile terminal, a location update message from said H.323 mobile terminal;
converting, by a gateway connected to said base transceiver station, said location update message into an Internet Protocol packet;
sending said Internet Protocol packet from said gateway to mobile switching center functionality via a local area network backbone; and
transmitting, by said mobile switching center functionality, said RAS message based upon said Internet Protocol packet to said visitor Gatekeeper.
